(19) United States
(12) Patent Application Publication
(10) Pub. No.: US 2019/0128700 A1
(43) Pub. Date: May 2, 2019

(54) MAGNETIC SENSOR

(71) Applicant: TDK Corporation, Tokyo (JP)

(72) Inventors: Keisuke UCHIDA, Tokyo (JP); Yuta SAITO, Tokyo (JP)

(21) Appl. No.: 16/170,089

(22) Filed: Oct. 25, 2018

(30) Foreign Application Priority Data
Oct. 31, 2017 (JP) 2017-210607

(51) Int. Cl. G01D 5/16

(52) U.S. Cl. CPC G01D 5/16

(57) ABSTRACT

A magnetic sensor according to the invention has an element portion having a magnetoresistive effect and a magnetically sensitive axis that is directed in a predetermined direction, and a soft magnetic body that is arranged near the element portion and that faces the element portion along at least a part of a portion other than both end portions thereof, as viewed in a direction of the magnetically sensitive axis. The soft magnetic body has protruding surfaces that protrude toward the element portion at said both end portions.

### BACKGROUND OF THE INVENTION

### Field of the Invention

The present application is based on, and claims priority from, JP Application No. 2017-210607, filed on Oct. 31, 2017, the disclosure of which is hereby incorporated by reference herein in its entirety.

The present invention relates to a magnetic sensor.

### Description of the Related Art

As a sensor for detecting the position of a moving object, a magnetic sensor that has an element having a magnetoresistive effect is known (see JP2009-300150). A magnetic sensor moves relative to a magnet and thereby detects a change in an external magnetic field that is generated by the magnet, and calculates the moving distance of the moving object based on the change in the external magnetic field that is detected.

JP2009-300150 discloses a magnetic sensor that has an element portion and soft magnetic bodies, as shown in FIG. 1 thereof. The element portion is elongate and exhibits a magnetoresistive effect. The soft magnetic bodies are provided on both sides of the element portion, as viewed in the height direction, and on the upper side of the element portion, as viewed in the direction of the long axis of the element portion. The magnetic sensor has a magnetically sensitive axis in parallel with the long axis of the element portion. JP2009-300150 further discloses that the soft magnetic body has a plain surface on the side facing the element portion. The soft magnetic body of the magnetic sensor protrudes further in the direction of the long axis thereof on both sides than the element portion, and both ends of the soft magnetic body are wider than the remaining portion of the soft magnetic body.

### SUMMARY OF THE INVENTIN

JP2009-300150, in which both ends of the soft magnetic body are formed wider than the remaining portion, provides a magnetic sensor that is improved in capability of shielding a magnetic field in a direction perpendicular to the magnetically sensitive axis.

However, a magnetic sensor that is capable of more effectively shielding a magnetic field (enhancing the magnetic field shielding factor) in directions other than the magnetically sensitive axis is required through improvement of the shape of the soft magnetic body.

The present invention aims at providing a magnetic sensor that is capable of more effectively shielding a magnetic field in directions other than the magnetically sensitive axis while maintaining the capacity of shielding a magnetic field in the direction of the magnetically sensitive axis.

A magnetic sensor of the present invention comprises: an element portion having a magnetoresistive effect and a magnetically sensitive axis that is directed in a predetermined direction; and a soft magnetic body that is arranged near the element portion and that faces the element portion along at least a part of a portion other than both end portions thereof, as viewed in a direction of the magnetically sensitive axis. The soft magnetic body has protruding surfaces that protrude toward the element portion at said both end portions.

The above and other objects, features and advantages of the present invention will become apparent from the following descriptions with reference to the accompanying drawings which illustrate examples of the present invention.

### BRIEF DESCRIPTION OF THE DRAWINGS

FIG. 1A is a view of the main portion of a magnetic sensor according to an embodiment, as viewed in the X axis direction;

FIG. 1B is a partial sectional view of the magnetic sensor cut along line 1B-1B in FIG. 1A;

FIG. 1C is a circuit diagram of the magnetic sensor according to the embodiment;

FIG. 1D is a sectional view of an element portion that constitutes the main portion of the magnetic sensor according to the embodiment;

FIG. 1E is a view of the main portion of a magnetic sensor according to a first modification, as viewed in the X axis direction;

FIG. 1F is a view of the main portion of a magnetic sensor according to a second modification, as viewed in the X axis direction;

FIG. 2 is a view of the main portion of a magnetic sensor according to a comparative example, as viewed in the X axis direction;

FIG. 3 is a graph showing magnetic field shielding factors in the X axis direction and in the Y axis direction that were measured by the magnetic sensor of the embodiment (and the first and second modifications) and a magnetic sensor of a comparative example; and

FIGS. 4A to 4H are views of the main portions of magnetic sensors according to third to tenth modifications, as viewed in the X axis direction, respectively.

### DETAILED DESCRIPTION OF EMBODIMENTS

Explanation will be given about an embodiment, as well as modifications of the embodiment (first to tenth modifications). First, the embodiment and the first and second modifications will be explained, and then the other modifications (the third to tenth modifications) will be explained.

### First Embodiment

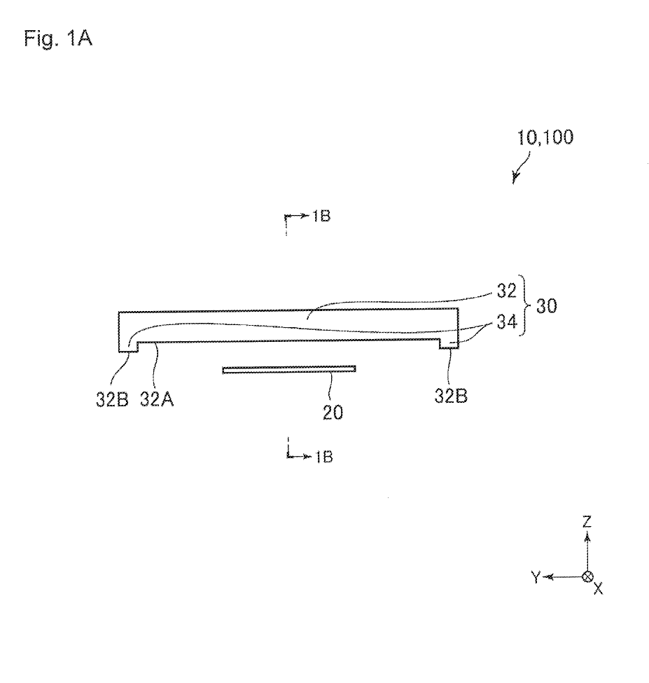

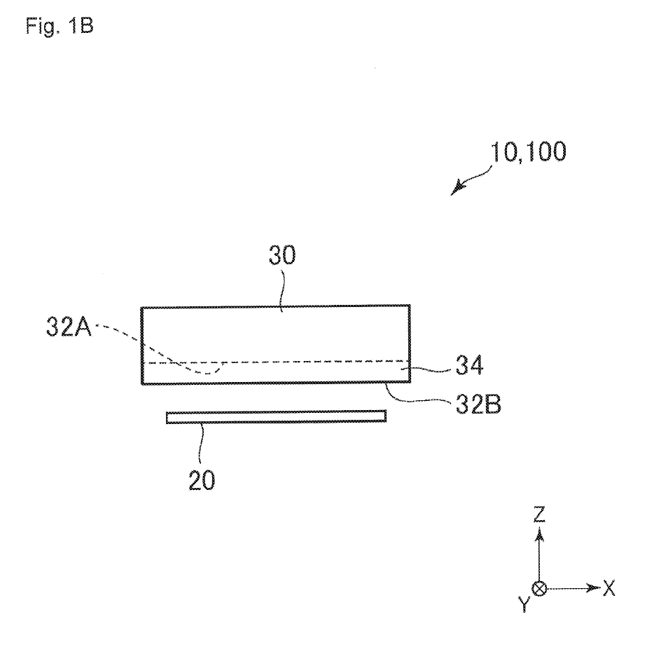

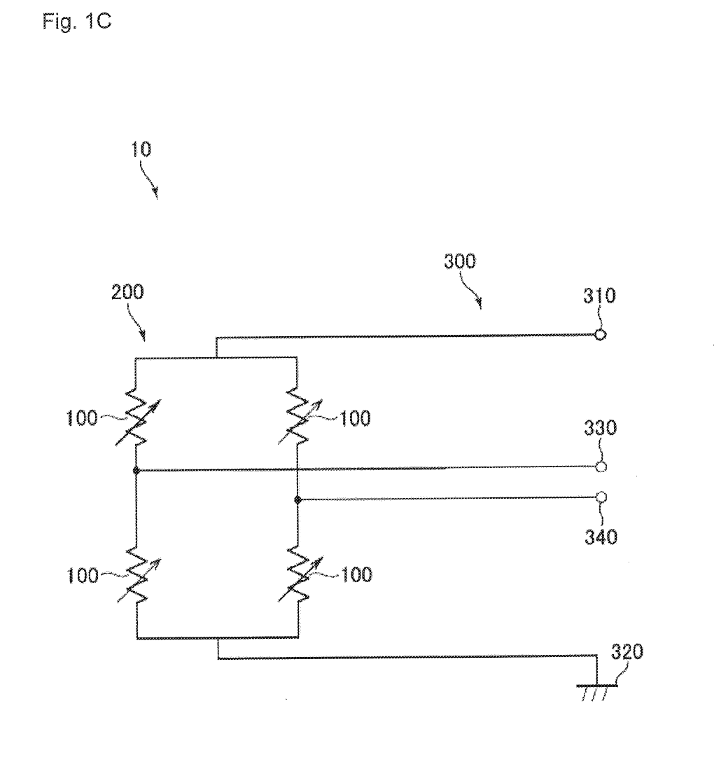

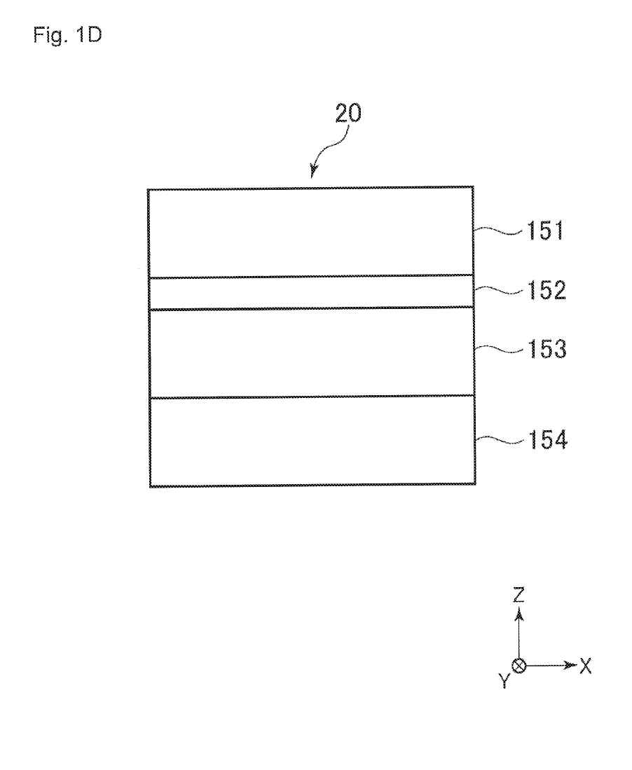

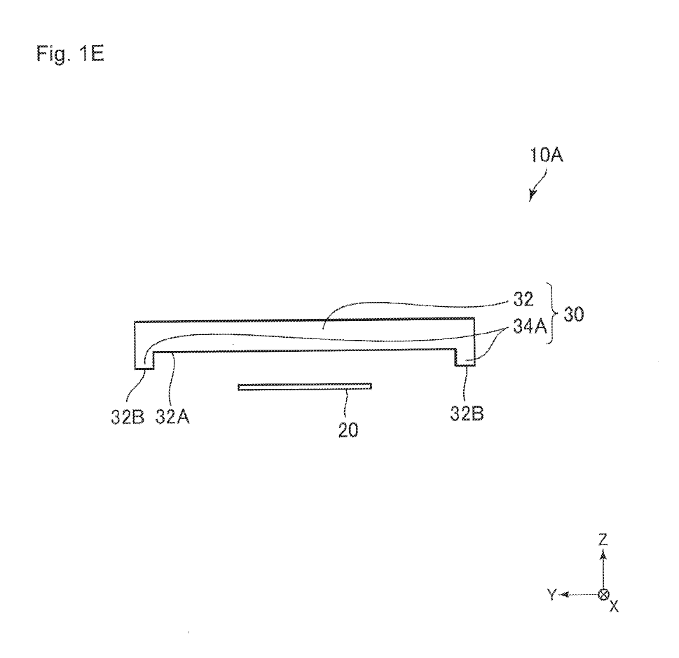

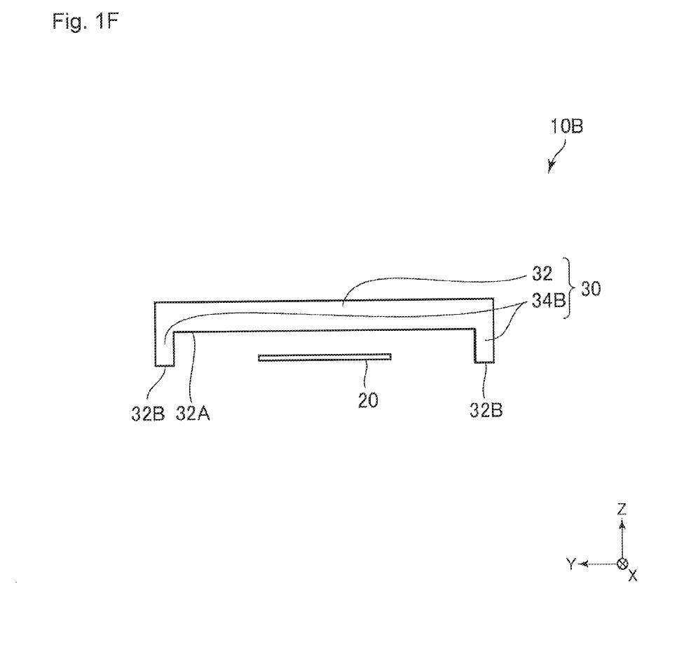

Magnetic sensor 10 (see FIGS. 1A to 1D) of the embodiment is, for example, a sensor for detecting the position of a moving object (not shown) having a magnet, that is, a positon sensor. Magnetic sensor 10 is configured to move relative to the above-mentioned magnet and thereby to detect a change in an external magnetic field that is generated by the magnet, and to calculate the moving distance of the moving object based on the change that is detected. Magnetic sensor 10 of the embodiment has a magnetically sensitive axis, which is the X axis (see FIGS. 1A and 1B etc.), described later, and detects a change in the magnetic field in the X axis direction (an example of a predetermined direction). In the following descriptions, the Z axis direction (see FIGS. 1A and 1B etc.) corresponds to the stacking direction of each element portion 20, described later, and the Y axis direction (see FIGS. 1A and 1B etc.) corresponds to a direction that is perpendicular both to the Z axis direction and to the X axis direction.

Magnetic sensor 10 is used, for example, for a lens position detecting mechanism that constitutes an auto focus mechanism or an optical shake correction mechanism of a camera of a mobile information terminal and the like.

Magnetic sensor 10 has magnetoresistive element portion 100 that is constructed by element portion 20 and shield 30 (an example of a soft magnetic body), as shown in FIGS. 1A to 1C.

As shown in FIG. 1C, magnetic sensor 10 has sensor portion 200, in which magnetoresistive element portions100 are bridge-connected to each other, and integrated circuit 300 having input terminal 310 that is electrically connected to sensor portion 200, ground terminal 320 and external output terminals 330, 340 etc.

Element portion 20 of the embodiment is, for example, elongate and has a magnetoresistive effect, described later Element portion 20 is arranged such that the direction of the long axis is in parallel with the X axis direction (see FIGS. 1A, 1B).

Element portion 20 has, for example, a typical spin-valve type film configuration, as shown in FIG. 1D. Specifically, element portion 20 includes free layer 151 whose magnetization direction is changed depending on an external magnetic field, pinned layer 153 whose magnetization direction is pinned relative to the external magnetic field, spacer layer 152 that is positioned between and that is in contact both with free layer 151 and with pinned layer 153, antiferromagnetic layer 154 that is adjacent to pinned layer 153 on the back side thereof, as seen from spacer layer 152. Free layer 151, spacer layer 152, pinned layer 153 and antiferromagnetic layer 154 are stacked above a substrate (not shown). Antiferromagnetic layer 154 fixes the magnetization direction of pinned layer 153 by the exchange coupling with pinned layer 153. Pinned layer 153 may also have a synthetic structure in which two ferromagnetic layers sandwich a nonmagnetic intermediate layer. Spacer layer 152 is a tunneling barrier layer that is formed of a nonmagnetic insulator, such as Al₂O₃. Accordingly, element portion 20 is a tunneling magnetoresistive element (a TMR element) having a tunneling magnetoresistive effect. A TMR element has a larger MR ratio and a larger output voltage from the bridge circuit, for example, than a GMR element.

Shield 30 of the embodiment has a function of absorbing a magnetic field that is applied, for example, in the Y axis direction. As a result, shield 30 has a function of attenuating sensitivity to a magnetic field in the Y axis direction that is detected by element portion 20. Shield 30 is formed, for example, of NiFe, CoFe, CoFeSiB, CoZrNb and the like.

Shield 30 has main portion 32 and a pair of protrusions 34, as shown in FIG. 1A. Main portion 32 is, for example, cuboid and is arranged near and on the upper side of element portion 20 along the Y axis direction (see FIGS. 1A and 1B).

Main portion 32 faces element portion 20 along at least a part of a region other than both end portions with regard to the Y axis direction (the central region), as shown in FIG. 1A (that is, as viewed in the X axis direction). Main portion 32 faces element portion 20 along the central region thereof with regard to the X axis direction, as shown in FIG. 1B (that is, as viewed in the Y axis direction).

Each protrusion 34 is, for example, cuboid and extends in the X axis direction. Specifically, protrusions 34 are arranged at both ends of main portion 32 with regard to a direction of the long axis thereof (the Y axis direction) such that protrusions 34 protrude downward from main portion 32, as shown in FIG. 1A. In other words, protrusions 34 are arranged on bottom surface 32A of main portion 32 (an example of a surface of shield 30 that faces element portion 20) at both end portions thereof, as viewed in the X axis direction. Accordingly, a pair of protruding surfaces 32B that protrude toward element portion 20 is formed at both end portions of shield 30. In other words, the surfaces of shield 30 that face element portion 20 is closer to element portion 20 at both end portions thereof (protruding surfaces 32B) than at a portion other than both end portions (a portion of bottom surface 32A that faces element portion 20) in the direction in which element portion 20 and shield 30 face each other (Z axis direction). A pair of protrusions 34 is arranged such that protrusions 34 sandwich element portion 20 in the Y axis direction (that is, protrusions 34 are arranged on both outer sides of element portion 20 with regard to the width direction thereof), as shown in FIG. 1A. In the present descriptions, protrusion 34 is a portion of shield 30 where protruding surface 32B is formed. In the embodiment, each protrusion 34 is arranged on the upper side of element portion 20. In other words, the protruding length (height) of each protrusion 34 from bottom surface 32A is smaller (shorter) than the distance between bottom surface 32A and element portion 20.

### [First and Second Modifications]

Next, the configurations and effect of the first and second modifications will be explained with reference to FIG. 1E and FIG. 1F, respectively. In the following descriptions, when the same elements are used in each modification as in the embodiment, the names and reference numerals in the embodiment will be used.

In magnetic sensor 10A of the first modification (see FIG. 1E), the protruding length of each protrusion 34A from bottom surface 32A is larger than the protruding length of each protrusion 34 from bottom surface 32A in magnetic sensor 10 of the embodiment (see FIG. 1A). In other words, the gap (the distance in the Z axis direction) between bottom surface 32A and each protruding surface 32B in the first modification is larger than the distance between bottom surface 32A and each protruding surface 32B in the embodiment. However, in the present modification, each protrusion 34A is arranged on the upper side of element portion 20 in the same manner as the embodiment. Magnetic sensor 10 A of the present modification is the same as magnetic sensor 10 of the embodiment except for the above.

The protruding length of each protrusion 34A from bottom surface 32A in magnetic sensor 10B of the second modification (see FIG. 1F) is larger than the protruding length in magnetic sensor 10 of the embodiment (see FIG. 1A). Further, in the present modification, unlike the embodiment, the tip end of each protrusion 34B (the lower tip end in the Z axis direction) is positioned below element portion 20. That is, in magnetic sensor 10B of the present modification, each protrusion 34B protrudes to a position where protrusion 34B overlaps with element portion 20, as viewed in the Y axis direction. Magnetic sensor 10B of the present modification is the same as magnetic sensor 10 of the embodiment except for the above.

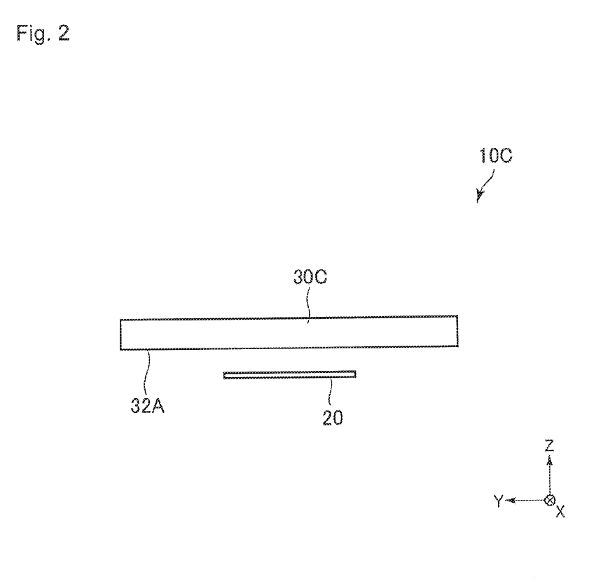

Next, the effect of the embodiment and the first and second modifications (the first and second effects) will be explained with reference to the drawing. In the following descriptions, the embodiment and the first and second modifications (see FIGS. 1A to 1F) will be compared to a comparative example (see FIG. 2), as needed. When the same elements are used in the comparative example as in the embodiment, the names and reference numerals in the embodiment will be used.

The first effect is obtained by protrusions 34 that are provided at both end portions of shield 30, which faces element portion 20 along a region other than both end portions (the central region), and that protrude toward element portion 20. In other words, the first effect is obtained by protruding surfaces 32B that are provided on both end portions of shield 30 and that protrude toward element portion 20. The first effect will be explained by comparing the embodiment and the first and second modifications to the comparative example.

Magnetic sensor 10C of the comparative example (see FIG. 2) is different from magnetic sensor 10 of the embodiment in that shield 30C does not include protrusions 34 (in other words, shield 30C consists only of main portion 32 of the embodiment). Magnetic sensor 100 of the comparative example has the same configuration as magnetic sensor 10 of the embodiment except for the above.

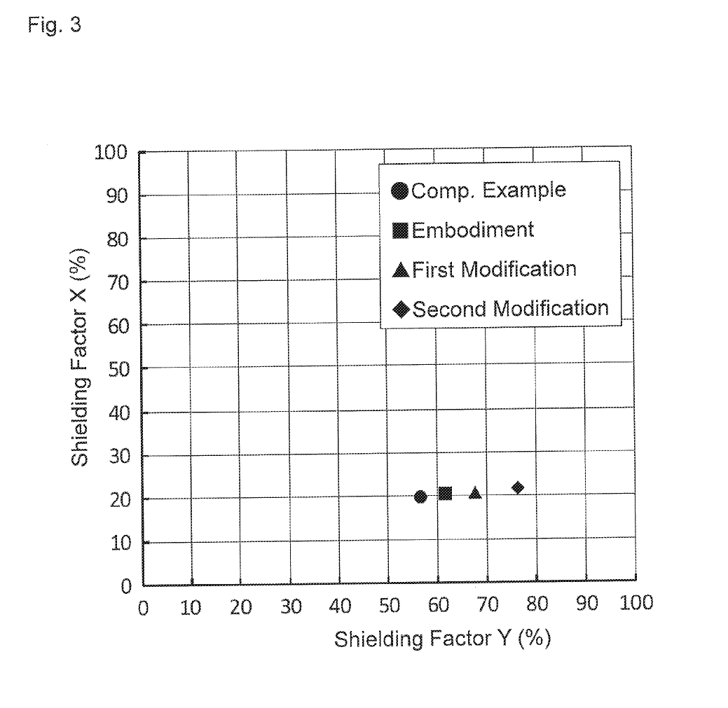

In the graph of FIG. 3, measurements of magnetic field shielding factors (rate of attenuation of a magnetic field) in the X axis direction and in the Y axis direction are shown. The measurements were obtained by applying a magnetic field to magnetic sensors 10, 10A and 10B of the embodiment and the first and second modifications and magnetic sensor 10C of the comparative example in an arbitrary direction. The horizontal axis of the graph in FIG. 3 shows a magnetic field shielding factor in the Y axis direction (hereinafter, referred to as a Y-shielding factor) and the vertical axis shows a magnetic field shielding factor in the X axis direction (hereinafter, referred to as an X-shielding factor). The shielding factor (%) is defined as [a magnetic field that is applied to element portion 20] (mT)/[external magnetic field] (mT))×100.

The X-shielding factor is an example of a magnetic field shielding factor in the direction of the magnetically sensitive axis. The Y-shielding factor is an example of a magnetic field shielding factor in the direction in which both end portions of main portion 32 (shield 30) are aligned (the Y axis direction).

It is desirable for each magnetic sensor 10, 10A, 10B, 10C that the Y-shielding factor is large and the X-shielding factor is small in the graph of FIG. 3 because it is desirable to (precisely) detect a magnetic field in the X axis direction while preventing (as much as possible) a magnetic field in the Y axis direction from being detected.

In the comparative example, the X-shielding factor was about 20%, and the Y-shielding factor was about 57%. In the embodiment, the X-shielding factor was about 20%, and the Y-shielding factor was about 62%. In the first modification, the X-shielding factor was about 21%, and the Y-shielding factor was about 67%. In the second modification, the X-shielding factor was about 21%, and the Y-shielding factor was about 73%.

From the above measurements, the embodiment and the first and second modifications can enhance the Y-shielding factor, as compared to the comparative example, while keeping the X-shielding factor substantially at the same level as the comparative example. Comparing the embodiment, first modification and the second modification to each other, the X-shielding factor was about the same level, but the larger the protruding length of protrusions 34, 34A, 34B is, the larger is the Y-shielding factor.

The inventor thinks that the reason why the embodiment and the first and second modifications show larger Y-shielding factors than the comparative example is as follows. In the embodiment and the first and second modifications, shield 30, 30A, 30B (see FIG. 1A, FIG. 1E and FIG. 1F, respectively) have protrusions 34, 34A, 34B that protrude toward element portion 20, unlike shield 30C of the comparative example, which is formed only of main portion 32 of the embodiment or the first or second modifications (see FIG. 2). In other words, protruding surfaces 32B that protrude toward element portion 20 are formed in shield 30, 30A, 30B (see FIGS. 1A, 1E and 1F). In the embodiment and the first and second modifications, a magnetic field that is applied in the Y axis direction is absorbed not only by main portion 32 but also by a pair of protrusions 34, 34A and 34B. Such an arrangement is believed to lead to the measurements in FIG. 3.

Accordingly, magnetic sensor 10, 10A, 10B of the embodiment and the first and second modifications can enhance magnetic field shielding effect in the Y axis direction while keeping magnetic field shielding effect in the X axis direction, as compared to magnetic sensor 10 C of the comparative example.

From the measurements shown in FIG. 3, it is found that the Y-shielding factor of the comparative example was less than 60%, while the Y-shielding factors of the embodiment and the first and second modifications are larger than 60%. Thus, the inventor thinks that it is possible in the embodiment and the first and second modifications to increase the Y-shielding factor from less than 60% to more than 60% by forming protruding surfaces 32B on both end portions of shield 30 that protrude toward element portion 20 (or by providing protrusions 34, 34A, 34B on both ends of shield 30).

A ratio of the Y-shielding factor relative to the X-shielding factor was less than three in the comparative example, while the ratio was larger than three in the embodiment and the first and second modification. Thus, the inventor thinks that it is possible in the embodiment and the first and second modifications to increase the ratio of the Y-shielding factor relative to the X-shielding factor to more than three by forming protruding surfaces 32B on both end portions of shield 30 that protrude toward element portion 20 (or by providing protrusions 34, 34A, 34B on both ends of shield 30).

The second effect is obtained by the arrangement of magnetic sensor 10B of the second modification, in which a pair of protrusions 34B protrude to positions where protrusions 34B overlap with element portion 20, as viewed in the Y axis direction. The second effect will be explained with reference to the graph of FIG. 3 and by comparing the second modification to the embodiment and the first modification.

As mentioned above (as shown in the graph of FIG. 3), the X-shielding factor was about the same level between the embodiment, the first modification and the second modification, but the larger the protruding length of protrusions 34, 34A, 34B is, the larger is the Y-shielding factor.

The inventor thinks that the reason why the Y-shielding factor increases as the protruding length of protrusions 34, 34A, 34B increase is as follows. A magnetic field that is applied in the Y axis direction is absorbed by main portion 32 and a pair of protrusions 34, 34A, 34B, as mentioned above, and as the protruding length of protrusions 34, 34A, 34B increases, a magnetic field in the Y axis direction more easily runs against protrusion 34, 34A, 34B, and accordingly, the magnetic field shielding factor in the Y axis direction increases. This is believed to lead to the measurements shown in FIG. 3.

Accordingly, the magnetic sensor 10B of the second modification can enhance magnetic field shielding effect in the Y axis direction while keeping magnetic field shielding effect in the X axis direction, as compared to an arrangement in which a pair of protrusions 34B does not protrude to positons where protrusions 34B overlap with element portion 20, as viewed in the Y axis direction.

### [Modifications (the Third to Tenth Modifications]

The present invention has been described by taking the embodiment and the first and second modifications as examples, but the present invention is not limited to these. For example, the following modifications are included in the scope of the present invention.

For example, in the embodiment, element portion 20 is arranged such that the long axis thereof is in parallel with the X axis direction (see FIGS. 1A and 1B). However, when magnetically sensitive axis is directed in the X axis direction, element portion 20 may be arranged such that the long axis thereof is in parallel with a direction other than the X axis direction. For example, element portion 20 may be arranged such that the long axis thereof is in parallel with the Y axis direction.

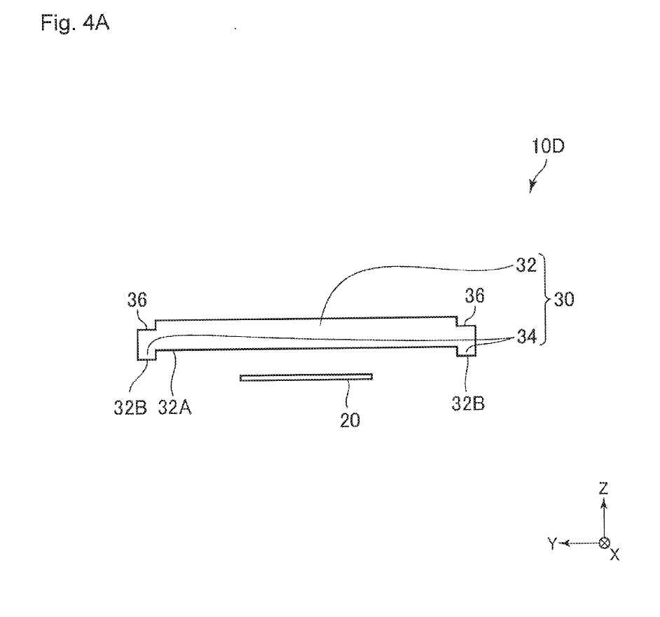

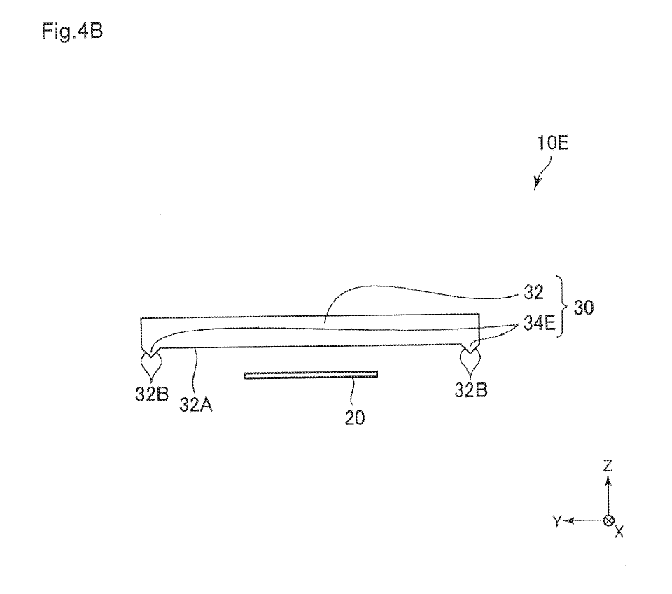

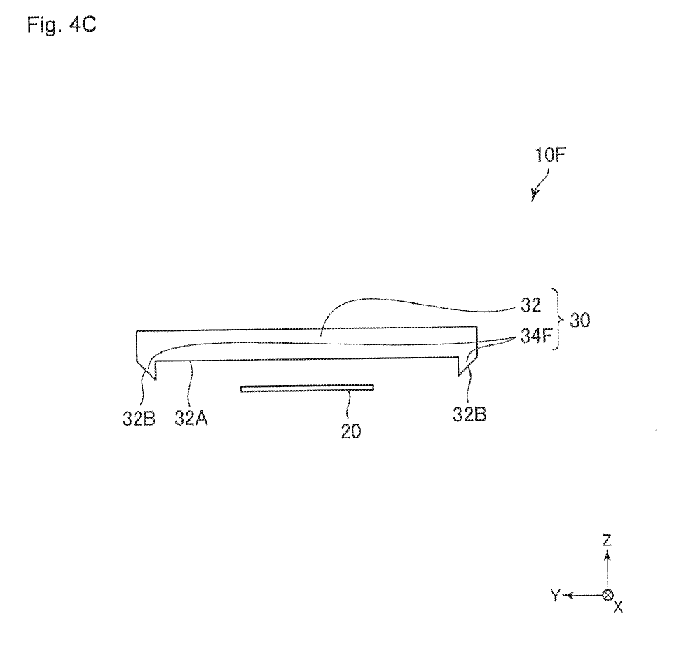

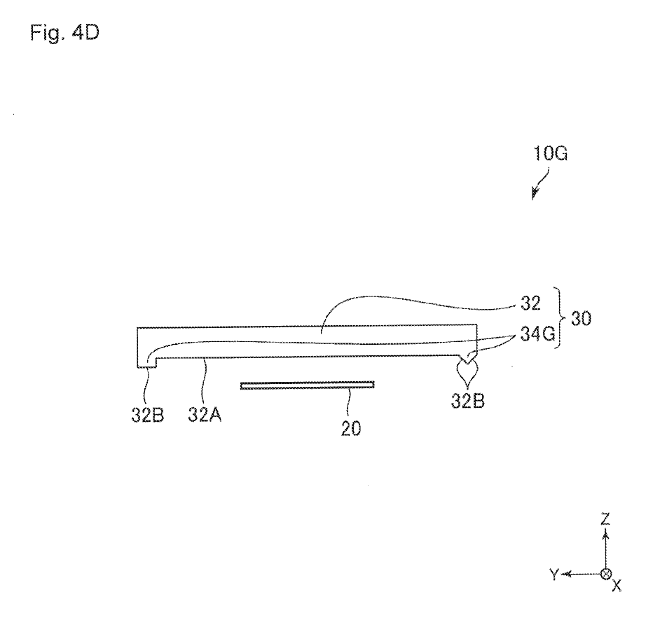

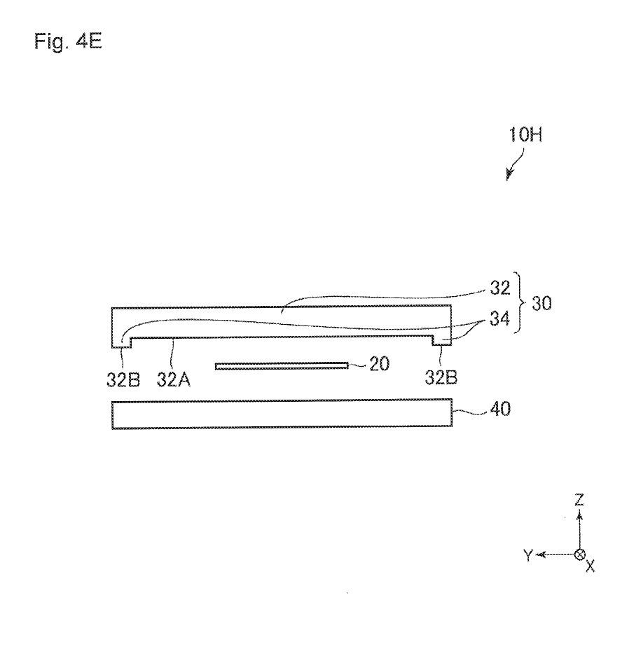

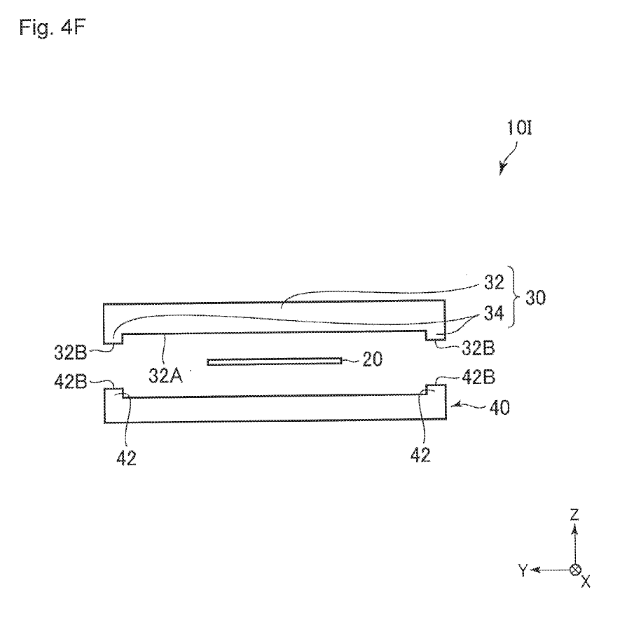

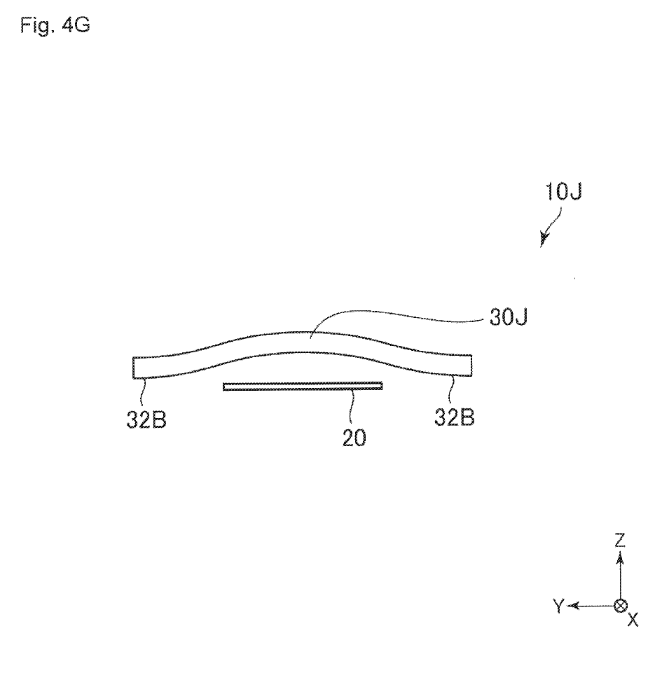

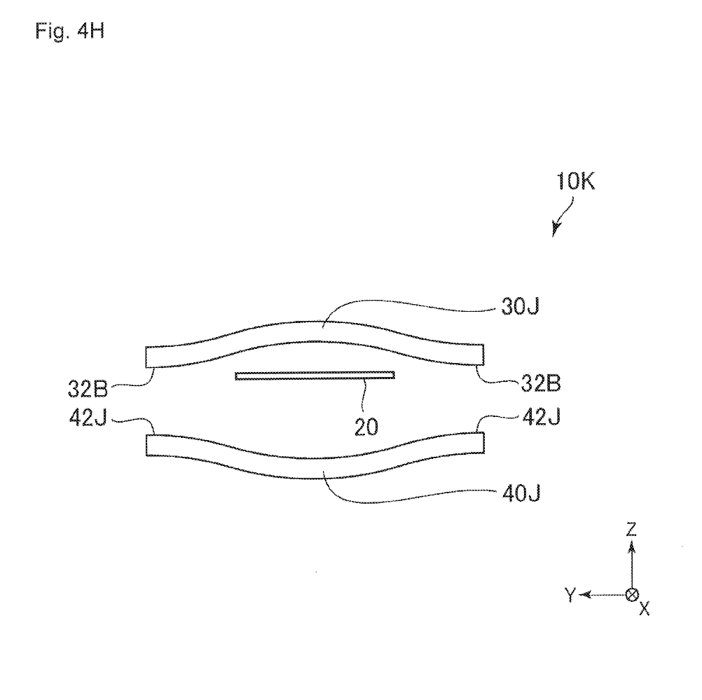

In the embodiment, main portion 32 that constitutes shield 30 is cuboid (see FIGS. 1A and 1B), However, main portion 32 may have a shape other than a cuboid as long as a pair of protrusions (or protruding surfaces) is formed on both ends of shield 30 such that the protrusions sandwich element portion 20 in the Y axis direction. For example, recesses (steps) 36 may be formed on the upper surface of main portion 32 on both ends thereof. See magnetic sensor 10D of the third modification shown in FIG. 4A.

In the embodiment, protrusions 34 are, as an example, cuboids and are arranged on the upper side of element portion 20 along the Y axis direction (see FIGS. 1A, 1B). However, each protrusion 34 may be formed into a shape other than cuboid as long as a pair of protrusions (or protruding surfaces) is formed on both sides of shield 30 such that the protrusions sandwich element portion 20 the Y axis direction. For example, each protrusion 34E may be a triangle, as viewed in the X axis direction. See magnetic sensor 10E of the fourth modification shown in FIG. 4B. Each protrusion 34F may be a triangle that is different from the triangle shown in FIG. 4B, as viewed in the X axis direction. See magnetic sensor 10F of the fifth modification shown in FIG. 40.

In the embodiment, each protrusion 34 is a cuboid as an example. This means that both protrusions 34 have a same shape (see FIGS. 1A and 1B). However, protrusions 34 do not need to have a same shape as long as a pair of protrusions (or protruding surfaces) is formed on both sides of shield 30 such that the protrusions sandwich element portion 20 the Y axis direction. For example, protrusions 34G may have different shapes. See magnetic sensor 10G of the sixth modification shown in FIG. 4D.

In the embodiment and each modification (the first to sixth modifications) mentioned above, a pair of protrusions (protrusions 34, 34A, 34B, 34E, 34F, 34G) is formed on both sides of shield 30, as viewed in the X axis direction (see FIGS. 1A, 1E, 1F, 4A to 4D), and each protrusion has a shape having an edge, such a triangle or a quadrangle, as viewed in the X axis direction. However, the protrusions may have a shape having no edge (not shown), such as a semi-circle, a semi-oval or a U-shape, as viewed in the X axis direction, as long as a pair of protrusions is formed on both sides of shield 30 such that the protrusions sandwich element portion 20 in the Y axis direction.

In the embodiment, shield 30 is arranged near and on the upper side of element portion 20 (see FIGS. 1A and 1B), and no explanation has been made regarding an arrangement below element portion 20. However, for example, shield 40 (an example of another soft magnetic body) may be arranged near and on the lower side of element portion 20 (on the back side of element portion 20, as viewed from shield 30). See magnetic sensor 10H of the seventh modification shown in FIG. 4E. According to the present modification, the Y-shielding factor can be further increased by shield 40.

In addition, shield 40 of magnetic sensor 10H of the seventh modification may be changed into a form having a pair of protrusions 42 (an example of another protrusion) on a surface of shield 40 that faces element portion 20 (on both sides thereof). See magnetic sensor 10I of the eighth modification in FIG. 4F. According to the present modification, the Y-shielding factor can be further increased by a pair of protrusions 42 (as compared to magnetic sensor 10H of the seventh modification). In this modification, protrusion surfaces 42B (protrusions 42) may be arranged such that protrusion surfaces 42B face respective protruding surfaces 32B of shield 30 in the Z axis direction.

In the embodiment, each protruding surface 32B that protrudes toward element portion 20 is formed in shield 30 (see FIGS. 1A and 1B) by arranging each protrusion 34 on bottom surface 32A of main portion 32. However, shield 30 does not have to include a pair of protrusions 34 as long as protruding surfaces 32B that protrude toward element portion 20 are formed on a surface of shield 30 that faces element portion 20 (on both side thereof). For example, protruding surfaces 32B may be formed on both sides of shield 30J, as viewed in the X axis direction, by forming shield 30J (another example of a soft magnetic body) into a curved element whose surface that faces element portion 20 is concave, as viewed in the X axis direction, See magnetic sensor 10J of the ninth modification shown in FIG. 4G

Shield 40J (having a pair of protruding surfaces 42J) that is curved in the same manner as shield 30J and that is concave as seen from element portion 20 may be arranged on the back side of element portion 20, as viewed from shield 30J. See magnetic sensor 10K of the tenth modification shown in FIG. 4H. According to the present modification, in addition to the first effect, the effects of the seventh modification (see FIG. 4E) and the ninth modification (see FIG. 4G) can be obtained.

In the embodiment and the modifications, the spacer layer that constitutes element portion 20 is a tunneling barrier layer, and element portion 20 is a TMR element. However, the spacer layer that constitutes element portion 20 may be a nonmagnetic conductive layer that is formed of a nonmagnetic metal, such as Cu, in order to form element portion 20 as a giant magnetoresistive element (GMR element). Element portion 20 may also be an anisotropic magnetoresistive element (AMR element).

An embodiment in which one from among the embodiment and the first to tenth modifications is combined with an element (or an idea) of other embodiment/modifications is included in the scope of the present invention. For example, the idea of the second modification (see FIG. 1F) may be combined with the ninth modification (see FIG. 4G). Specifically, in magnetic sensor 10J of the ninth modification, protruding surfaces 32B of shield 30J may be shaped such that they overlap with element portion 20, as viewed in the Y axis direction. This combination will have the second effect and the effect of the above-mentioned ninth modification, as well as the first effect.

Furthermore, for example, in magnetic sensor 101 of the eighth modification (see FIG. 4F), shield 30, shield 40 or both shield 30 and shield 40 may be replaced with shield 30 of magnetic sensor 10G of the sixth modification shown in FIG. 4D.

The embodiment has been described by taking a position sensor as an example. However, magnetic sensor 10 of the embodiment may be a sensor other than a positon sensor as long as magnetic sensor 10 detects a magnetic field that is applied in the X axis direction. For example, magnetic sensor 10 may be a compass that detects terrestrial magnetism, an angle sensor, an encoder and so on.

Although certain preferred embodiments of the present invention have been shown and described in detail, it should be understood that various changes and modifications may be made without departing from the spirit or scope of the appended claims.

What is claimed is:

1. A magnetic sensor comprising:
an element portion having a magnetoresistive effect and a magnetically sen ve axis that is directed in a predetermined direction; and
a soft magnetic body that is arranged near the element portion and that faces the element portion along at least a part of a portion other than both end portions thereof, as viewed in a direction of the magnetically sensitive axis,
wherein the soft magnetic body has protruding surfaces that protrude toward the element portion at said both end portions.

2. The magnetic sensor according to claim 1, wherein the soft magnetic body includes protrusions having the protruding surfaces, and the protrusions protrude to positions where the protrusions overlap with the element portion, as viewed in a direction that is perpendicular both to a direction in which the element portion and the soft magnetic body face each other and to the direction of the magnetically sensitive axis.

3. The magnetic sensor according to claim 1, wherein the soft magnetic body is a curved element whose surface that faces the element portion is concave, as viewed in the direction of the magnetically sensitive axis, and the protruding surfaces are formed on both sides of the curved element, as viewed in the direction of the magnetically sensitive axis.

4. The magnetic sensor according to claim 1, further comprising another soft magnetic body that is arranged near the element portion and that sandwiches the element portion together with the soft magnetic body.

5. The magnetic sensor according to claim 4, wherein said another soft magnetic body faces the element portion along at least a part of a portion other than both end portions thereof, as viewed in the direction of the magnetically sensitive axis, and said another soft magnetic body has other protruding surfaces that protrude toward the element portion at said both end portions thereof.

6. The magnetic sensor according to claim 5, wherein said other protruding surfaces face the respective protruding surfaces.

7. A magnetic sensor comprising:
an element portion having a magnetoresistive effect and a magnetically sensitive axis that is directed in a predetermined direction; and
a soft magnetic body that is arranged near the element portion and that faces the element portion along at least a part of a portion other than both end portions thereof, as viewed in a direction of the magnetically sensitive axis,
wherein a surface of the soft magnetic body on a side of the element portion is closer to the element portion at said both end portions than at a portion other than said both end portions in a direction in which the element portion and the soft magnetic body face each other.

8. The magnetic sensor according to claim 1, wherein a magnetic field shielding factor of the soft magnetic body is larger than 60% in a direction in which said both end portions are aligned.

9. The magnetic sensor according to claim 1, wherein a ratio of a magnetic field shielding factor of the soft magnetic body in a direction in which said both end portions are aligned to a magnetic field shielding factor of the soft magnetic body in a direction of the magnetically sensitive axis is larger than 3.

10. The magnetic sensor according to claim 1, wherein the element portion exhibits a tunneling magnetoresistive effect.

11. The magnetic sensor according to claim 1, wherein the element portion exhibits a giant magnetoresistive effect.
